(19) United States
(12) Patent Application Publication
(10) Pub. No.: US 2026/0300218 A1
(43) Pub. Date: Oct. 1, 2026

(54) CONSTRAINT-NATIVE COMPUTATION THROUGH CONTINUOUS RESOLUTION OF INTERACTING PHYSICAL CONSTRAINTS IN A MEDIUM LACKING STORED COMPUTATIONAL TOPOLOGY

(71) Applicant: Anil P Rami, MOUNDSVILLE, WV (US)

(72) Inventor: Anil P Rami, MOUNDSVILLE, WV (US)

(21) Appl. No.: 19/700,285

(22) Filed: Jun. 7, 2026

Related U.S. Application Data
(63) Continuation of application No. 19/452,222, filed on Jan. 16, 2026.

(51) Int. Cl. G06F 15/78

(52) U.S. Cl. CPC G06F 15/7867

(57) ABSTRACT

Systems and methods are disclosed for performing computation through continuous physical evolution within a medium lacking stored computational topology. Computation arises through continuous resolution of interacting physical constraints governing evolution of the medium during operation. Physical constraints may comprise geometry, boundary conditions, material properties, field interactions, energy relationships, domain interactions, environmental conditions, governing physical relationships, or combinations thereof. Computational trajectories may emerge during operation without constituting stored computational structures. Repeated physical evolution may modify governing physical parameters of the medium and influence subsequent convergence behavior without storing computational pathways or routing structures. Resulting physical states may be observed to determine output. Observation measures consequences of computation without constituting the computational mechanism itself. The disclosed systems distinguish physical constraints that participate in computation from stored computational topology that encodes computational mappings, routing arrangements, logical organization, computational pathways, or computational outcomes prior to operation.

### CROSS-REFERENCE TO RELATED APPLICATIONS

This application is a continuation of U.S. patent application Ser. No. 19/452,222, titled “FIELD-BASED LIGHT COMPUTING WITHOUT STORED TOPOLOGY AND METHODS OF DECODING RESULTING FIELD STATES,” filed Jan. 15, 2026, the entirety of which is incorporated herein by reference. This application is further related to U.S. patent application Ser. No. 19/455,843, titled “NONLINEAR PHYSICAL COMPUTING ARCHITECTURE WITH SUBSTRATE-NATIVE MEMORY AND HISTORY-DEPENDENT COMPUTATION”; Ser. No. 19/547,362, titled “NONLINEAR PHYSICAL COMPUTING ARCHITECTURE WITH RESET-VERIFIED CONVERGENCE ACCELERATION AND KINETIC ENERGY MANAGEMENT”; Ser. No. 19/549,231, titled “NONLINEAR PHYSICAL COMPUTING ARCHITECTURE WITH DOMAIN-WIDE PARAMETER-FIELD RESHAPING, ATTRACTOR-LANDSCAPE MODIFICATION, GRADIENT PERSISTENCE MODULATION, AND MULTI-DOMAIN ORCHESTRATION”; Ser. No. 19/640,336, titled “NONLINEAR PHYSICAL COMPUTING ARCHITECTURE WITH DYNAMIC INTRA-SUBSTRATE DOMAIN SEGMENTATION AND CONTROLLED DOMAIN EVOLUTION”; and Ser. No. 19/660,178, titled “PHYSICAL COMPUTING SYSTEM WITH NON-RECONSTRUCTIVE AND HIERARCHICAL FIELD-STATE DECODING”; the entireties of which are incorporated herein by reference.

### FIELD OF THE INVENTION

The present disclosure relates generally to computational systems and computational architectures. More particularly, the disclosure relates to systems and methods in which computation arises through continuous physical evolution and resolution of interacting physical constraints within media lacking stored computational topology.

### BACKGROUND OF THE INVENTION

Conventional computational systems generally perform computation through execution of stored instructions, traversal of predefined computational pathways, activation of logical structures, propagation through routing networks, manipulation of stored state representations, or combinations thereof.

Digital processors, graphical processing units, neural networks, photonic routing systems, analog computational circuits, and other conventional architectures typically depend upon computational organization encoded prior to operation. Such organization may be embodied in routing arrangements, logical organizations, computational pathways, switching networks, weight matrices, interconnection structures, or other predefined computational topology.

Although physical processes participate in operation of such systems, the computational organization itself remains encoded within structure established prior to operation. Computation therefore proceeds through execution, traversal, activation, propagation, or manipulation of previously established computational organization.

In contrast, physical systems frequently exhibit complex evolution arising from interaction among material properties, field relationships, boundary conditions, geometric constraints, energy relationships, environmental conditions, and other governing physical factors. Such evolution may produce convergence behavior, emergent organization, attractor behavior, oscillatory behavior, persistence effects, and other dynamic phenomena.

Existing computational architectures generally treat such physical phenomena as mechanisms operating within or beneath computational structure rather than as the computational mechanism itself.

Accordingly, a need exists for computational architectures in which computation arises directly through physical evolution without requiring stored computational topology.

### SUMMARY OF THE INVENTION

In various embodiments disclosed herein, computation arises through continuous resolution of interacting physical constraints during physical evolution of a medium lacking stored computational topology.

Physical constraints participate directly in computation without constituting stored computational structure. Such constraints may comprise geometry, boundary conditions, material properties, field interactions, energy relationships, domain interactions, environmental conditions, governing physical relationships, or combinations thereof.

Computation is performed through physical evolution governed by interacting physical constraints rather than through execution of stored instructions, traversal of predefined computational pathways, activation of encoded computational elements, or operation of stored routing topology.

Computational trajectories may emerge during operation without constituting stored computational entities. Such trajectories arise as consequences of physical evolution rather than as predefined computational pathways.

Repeated physical evolution may modify governing physical parameters of the medium and thereby influence subsequent convergence behavior without storing trajectories, routing structures, computational pathways, or computational topology.

Continuous resolution of interacting physical constraints may produce convergence toward one or more resulting physical states. Resulting physical states may be observed to determine computational output. Observation measures consequences of computation and does not constitute the computational mechanism itself.

### Definitions

As used herein, the term “physical evolution” refers to changes in one or more physical states of a medium including field states, excitation states, material states, domain states, energy distributions, temporal characteristics, spatial characteristics, response characteristics, persistence characteristics, or combinations thereof.

As used herein, the term “physical constraint” refers to a property, relationship, condition, interaction, governing relationship, or combination thereof that influences physical evolution of a medium during operation.

As used herein, the term “constraint resolution” refers to evolution arising from interaction among two or more physical constraints influencing physical behavior of a medium.

As used herein, the term “stored computational topology” refers to physical structure configured to encode computational mappings, routing arrangements, logical organization, computational pathways, computational outcomes, correspondences between inputs and outputs, or combinations thereof prior to operation.

As used herein, the term “trajectory” refers to a transient manifestation of physical evolution occurring during operation of a medium.

As used herein, the term “persistence” refers to retention of one or more physical conditions capable of influencing subsequent physical evolution.

As used herein, the term “convergence” refers to a tendency of physical evolution to approach, stabilize within, transition between, or otherwise exhibit preference for one or more resulting physical states.

### DETAILED DESCRIPTION

### Distinction Between Physical Constraints and Stored Computational Topology

Physical constraints and stored computational topology are distinct concepts within the disclosed architecture. Physical constraints participate in computation by influencing physical evolution of a medium during operation. Stored computational topology comprises physical structure configured to encode computational mappings, routing arrangements, logical organization, computational pathways, computational outcomes, correspondences between input conditions and computational outcomes, or combinations thereof prior to operation.

A physical feature does not constitute stored computational topology merely because it materially influences physical evolution, contributes to repeatable behavior, contributes to convergence behavior, or strongly affects resulting system behavior. Physical constraints influence evolution without specifying computational mappings or computational outcomes. The distinction is determined by whether a physical feature encodes computation or participates in computation.

Emergent trajectories, emergent attractors, emergent state patterns, emergent convergence behavior, and emergent physical organization arising during operation do not constitute stored computational topology solely by virtue of their emergence during operation. Modification of governing physical parameters resulting from prior physical evolution does not constitute stored computational topology where such modification arises through interaction during operation rather than through encoding of computational structure prior to operation.

### Computation Through Constraint Resolution

In the disclosed architecture, computation arises through continuous resolution of interacting physical constraints during physical evolution of a medium lacking stored computational topology. Physical evolution may be influenced by excitation introduced into the medium, existing physical conditions, governing physical relationships, boundary conditions, geometry, material properties, field interactions, energy relationships, domain interactions, environmental conditions, or combinations thereof.

Unlike execution-based computational systems, computation is not performed through traversal of predefined computational pathways, activation of encoded logical structures, execution of stored instructions, or propagation through stored routing topology. Instead computation arises through physical evolution itself. Interacting physical constraints continuously influence one another during operation and the resulting evolution constitutes ongoing resolution of such constraints.

### Transient Trajectories and Emergent Evolution

Transient trajectories may arise during physical evolution as a consequence of continuous resolution of interacting physical constraints. Such trajectories may comprise propagation behavior, state transitions, domain behavior, field evolution, energy redistribution, oscillatory behavior, convergence behavior, or combinations thereof. Transient trajectories are not stored as explicit computational entities and do not constitute independently addressable computational structures.

Repeatable resulting states or repeatable classes of trajectories do not imply stored computational topology. Similarly, repeatable convergence behavior, repeatable attractor behavior, or repeatable state evolution do not imply existence of stored computational pathways or routing structure.

### Persistence and Parameter Modification

Repeated physical evolution may modify one or more governing physical parameters of the medium. Such modification may arise through repeated excitation, repeated constraint resolution, repeated physical evolution, material response, domain interaction, environmental interaction, field interaction, or combinations thereof.

Persistence refers to retention of one or more physical conditions capable of influencing subsequent physical evolution and subsequent constraint resolution. Persistence does not require storage of trajectories, routing structures, computational pathways, computational mappings, logical organization, or stored computational topology. Effects of prior physical evolution may therefore influence subsequent physical evolution without requiring storage of computational trajectories as explicit computational entities.

### Convergence and Attractor Behavior

During physical evolution, continuous resolution of interacting physical constraints may result in convergence toward one or more resulting physical states. Convergence may arise through interaction among excitation, geometry, boundary conditions, material properties, field interactions, energy relationships, domain interactions, persistence conditions, environmental conditions, governing physical parameters, or combinations thereof.

Convergence behavior and attractor behavior arise from ongoing physical evolution governed by interacting physical constraints rather than from execution of stored instructions, traversal of predefined computational pathways, or activation of encoded computational structure. Repeated physical evolution may modify governing physical parameters and thereby influence subsequent convergence behavior without requiring storage of computational trajectories.

### Observation and Output Determination

Resulting physical states produced through continuous resolution of interacting physical constraints during physical evolution may be observed to determine computational output. Observation is not required to participate in computation and does not itself constitute constraint resolution, computational evolution, or the computational mechanism itself.

In certain embodiments, output may be determined through measurement of reduced-dimensional characteristics of the medium without requiring reconstruction of complete medium state. Observation may occur through optical, electrical, magnetic, thermal, acoustic, piezoelectric, electromagnetic, mechanical, or other measurement mechanisms. In certain embodiments, observed physical states may directly influence physical action without requiring symbolic representation of intermediate computational states.

### Exemplary Embodiments

The disclosed architecture is not limited to any particular physical medium. In various embodiments, the medium may comprise photonic media, optical media, photorefractive media, ferroelectric media, piezoelectric media, electrical media, magnetic media, acoustic media, mechanical media, fluidic media, chemical media, thermal media, quantum media, biological media, hybrid physical media, or combinations thereof.

In certain embodiments, the medium may comprise photorefractive materials in which physical evolution arises through interaction among optical excitation, material response, field interactions, persistence behavior, and governing physical constraints. In certain embodiments, the medium may comprise ferroelectric materials in which domains, domain interactions, field interactions, persistence characteristics, and material properties participate in physical evolution. In certain embodiments, the medium may comprise piezoelectric materials configured to generate observable outputs responsive to resulting physical states.

1. A computing system comprising: a physical medium lacking stored computational topology; one or more inputs configured to introduce excitation into said physical medium; wherein computation arises through continuous resolution of interacting physical constraints within said physical medium during physical evolution of said physical medium; wherein said physical constraints influence evolution of said physical medium without constituting stored computational structure; wherein computational trajectories may emerge during said evolution without being stored as explicit computational entities; and wherein output is determined from one or more physical observables of resulting physical states produced by said evolution.

2. The system of claim 1, wherein said physical constraints comprise geometry of said medium.

3. The system of claim 1, wherein said physical constraints comprise one or more boundary conditions of said medium.

4. The system of claim 1, wherein said physical constraints comprise material properties of said medium.

5. The system of claim 1, wherein said physical constraints comprise field interactions within said medium.

6. The system of claim 1, wherein said physical constraints comprise domain interactions within said medium.

7. The system of claim 1, wherein said physical constraints influence evolution without encoding routing, computational pathways, logical organization, computational mappings, or computational outcomes.

8. The system of claim 1, wherein repeatable resulting physical states do not constitute stored computational topology.

9. The system of claim 1, wherein computation occurs without traversal of predefined computational pathways.

10. The system of claim 1, wherein repeated physical evolution modifies governing physical parameters of said medium without storing computational trajectories, routing structures, or computational topology.

11. The system of claim 10, wherein modification of said governing physical parameters influences subsequent physical evolution of said medium.

12. The system of claim 1, wherein continuous resolution of interacting physical constraints produces convergence toward one or more resulting physical states.

13. The system of claim 12, wherein convergence behavior is influenced by modified governing physical parameters.

14. The system of claim 12, wherein attractor behavior arises as a consequence of continuous resolution of interacting physical constraints.

15. The system of claim 1, wherein output is determined from reduced-dimensional characteristics of said medium without requiring reconstruction of complete medium state.

16. The system of claim 1, wherein observed physical states are coupled directly to one or more actuators without requiring symbolic representation of intermediate computational states.

17. A method of computation comprising: introducing excitation into a physical medium lacking stored computational topology; allowing said excitation to evolve within said physical medium;
continuously resolving interacting physical constraints during physical evolution of said physical medium; producing one or more resulting physical states through said evolution; observing one or more physical observables associated with said resulting physical states; and determining computational output from said observed physical observables.

18. A physical computational medium comprising: one or more physical structures, materials, domains, field interactions, boundary conditions, governing relationships, or combinations thereof configured to support physical evolution within said medium; wherein interacting physical constraints within said medium govern said physical evolution; wherein computation arises through continuous resolution of said interacting physical constraints; wherein said medium lacks stored computational topology encoding computational mappings, routing arrangements, logical organization, computational pathways, or computational outcomes prior to operation; and wherein resulting physical states produced by said evolution are observable to determine computational output.

19. A computational output determination system comprising: a physical medium in which computation occurs through continuous resolution of interacting physical constraints during physical evolution; one or more observation mechanisms configured to measure physical observables associated with resulting physical states of said medium; and an output determination mechanism configured to determine output from said physical observables; wherein observation measures consequences of computation and does not constitute the computational mechanism itself.

20. A computational system comprising: a physical medium configured to support physical evolution governed by interacting physical constraints; wherein repeated physical evolution modifies one or more governing physical parameters of said medium; wherein modification of said governing physical parameters influences subsequent convergence behavior of said medium; wherein convergence behavior arises from continuous resolution of interacting physical constraints during physical evolution; and wherein said modification occurs without storing computational trajectories, routing structures, or computational topology as explicit computational entities.
